(19) United States
(12) Patent Application Publication
(10) Pub. No.: US 2008/0043995 A1
(43) Pub. Date: Feb. 21, 2008

(54) Histogram for controlling a telephone

(75) Inventors: Justin L. O'Shea, Gilbert, AZ (US); Harold Downey, Tempe, AZ (US)

Correspondence Address: Paul F. Wille, 6407 East Clinton St., Scottsdale, AZ, 85254, US

(73) Assignee: Acoustic Technologies, Inc., Mesa, AZ (US)

(21) Appl. No.: 11/497,989

(22) Filed: Aug. 1, 2006

(51) Int. Cl. H04M 1/00; H04M 9/00

(52) U.S. Cl. 379/388.06

(57) ABSTRACT

A telephone is operated in accordance with a histogram of data taken from the operation of one of its components, such as an echo cancelling circuit. The histogram provides a variable threshold for comparison with other signals or a variable control signal.

### BACKGROUND OF THE INVENTION

This invention relates to a method for controlling the operation of a telephone and, in particular, to a method for operating a telephone in accordance with a histogram of data.

As used herein, “telephone” is a generic term for a communication device that utilizes, directly or indirectly, a dial tone from a licensed service provider. As such, “telephone” includes desk telephones (see FIG. 1), cordless telephones (see FIG. 2), speakerphones (see FIG. 3), and hands-free kits (see FIG. 4). The invention is particularly useful for speakerphones or hands-free kits but has broader utility; e.g. intercoms.

There are many sources of noise in a telephone system. Some noise is acoustic in origin while other noise is electronic, from the telephone network, for example. As used herein, “noise” refers to any unwanted sound, whether the unwanted sound is periodic, purely random, or somewhere in-between. As such, noise includes background music, voices of people other than the desired speaker, tire noise, wind noise, and so on. As thus broadly defined, noise could include an echo of the speaker's voice. However, echo cancellation is treated separately in a telephone.

Acoustic echo cancelling can be accomplished in several different ways. For example, simple attenuation of the received signal can reduce echo, provided that there is no “far end” or received speech. Another example is subtraction, wherein a fraction of the “near end” or transmitted speech is subtracted from the received signal. A combination of techniques is often used to provide optimum results.

There is a problem using a combination of techniques in that the optimum solution changes with conditions; e.g., volume (gain) levels, path changes, ambient noise levels or content. Variations in transducers and placement of transducers can also affect the optimum solution but will not usually change within a single call. “Path” refers primarily to a direct route from the loudspeaker of a speakerphone or hands-free kit to a microphone and secondarily to indirect routes taken by sound, e.g., bouncing off nearby surfaces or coupled by an enclosure.

In view of the foregoing, it is therefore an object of the invention to provide a control circuit that adapts to changing conditions based upon histogram data.

Another object of the invention is to provide a control circuit that adapts to changing conditions based upon histogram data on the operation of an echo cancelling circuit.

A further object of the invention is to provide a variable threshold signal based upon histogram data of the operation of a circuit.

### SUMMARY OF THE INVENTION

The foregoing objects are achieved in this invention in which the difference in magnitude between the output and the input of an electronic circuit is measured. A plurality of differences are accumulated and a histogram is made. In the histogram, the number of samples within a narrow range of differences is stored in a register. A plurality of registers corresponds to the plurality of ranges that constitute the histogram. The number of samples in a predetermined register is the control signal. The number can be used directly or for comparison with other data.

### BRIEF DESCRIPTION OF THE DRAWINGS

A more complete understanding of the invention can be obtained by considering the following detailed description in conjunction with the accompanying drawings, in which:

FIG. 1 is a perspective view of a desk telephone;

FIG. 2 is a perspective view of a cordless telephone;

FIG. 3 is a perspective view of a conference phone or a speakerphone;

FIG. 4 is a perspective view of a hands-free kit;

FIG. 5 is a perspective view of a cellular telephone (“cellphone”);

FIG. 6 is a block diagram of the major components of a cellular telephone;

FIG. 7 is a detailed block diagram of an audio processing circuit;

FIG. 8 is a block diagram illustrating a preferred embodiment of the invention; and

FIG. 9 is a chart for explaining the operation of the invention.

Those of skill in the art recognize that, once an analog signal is converted to digital form, all subsequent operations can take place in one or more suitably programmed microprocessors. Reference to “signal,” for example, does not necessarily mean a hardware implementation or an analog signal. Data in memory, even a single bit, can be a signal. In other words, a block diagram can be interpreted as hardware, software, e.g. a flow chart or an algorithm, or a mixture of hardware and software. Programming a microprocessor is well within the ability of those of ordinary skill in the art, either individually or in groups.

### DETAILED DESCRIPTION OF THE INVENTION

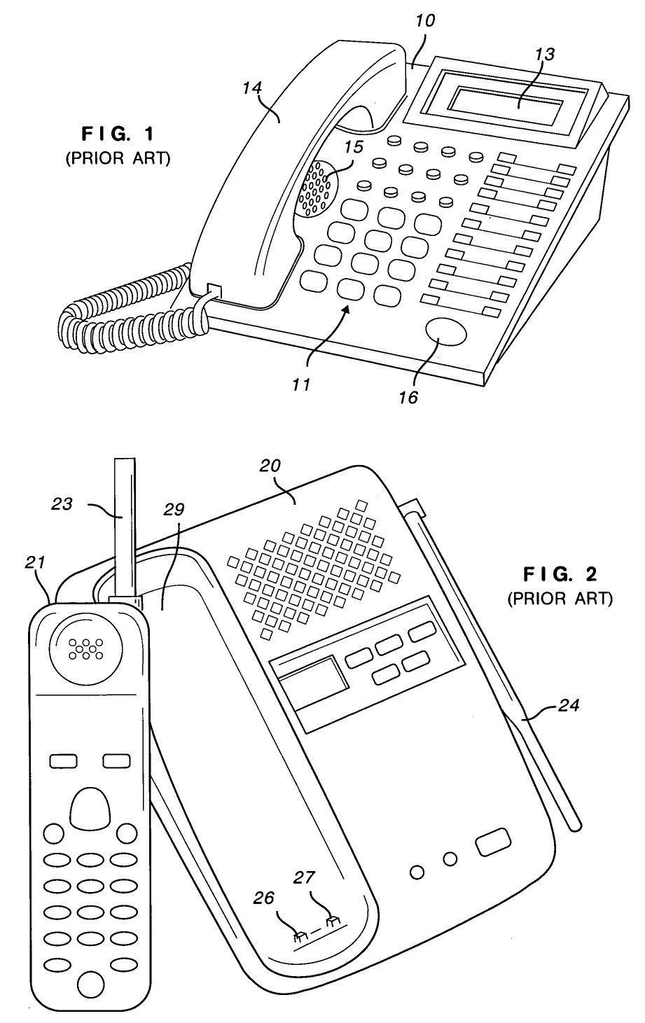

This invention finds use in many applications where the electronics is essentially the same but the external appearance of the device may vary. FIG. 1 illustrates a desk telephone including base 10, keypad 11, display 13 and handset 14. As illustrated in FIG. 1, the telephone has speakerphone capability including loudspeaker 15 and microphone 16. The cordless telephone illustrated in FIG. 2 is similar except that base 20 and handset 21 are coupled by radio frequency signals, instead of a cord, through antennas 23 and 24. Power for handset 21 is supplied by internal batteries (not shown) charged through terminals 26 and 27 in base 20 when the handset rests in cradle 29.

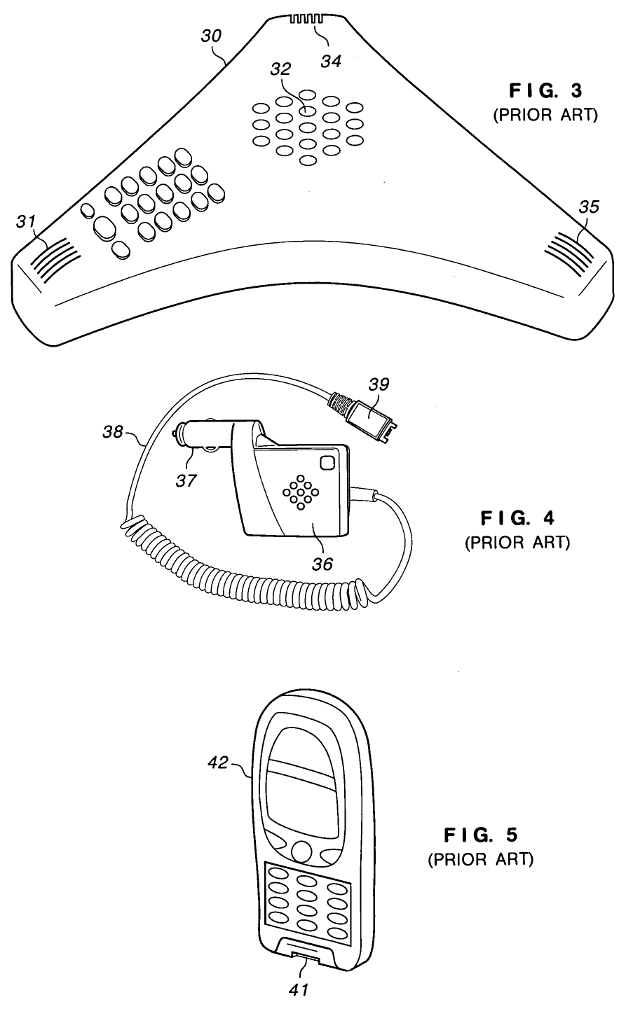

FIG. 3 illustrates a conference phone or speakerphone such as found in business offices. Telephone 30 includes microphone 31 and loudspeaker 32 in a sculptured case. Telephone 30 may include several microphones, such as microphones 34 and 35 to improve voice reception or to provide several inputs for echo rejection or noise rejection, as disclosed in U.S. Pat. No. 5,138,651 (Sudo).

FIG. 4 illustrates what is known as a hands-free kit for providing audio coupling to a cellular telephone, illustrated in FIG. 5. Hands-free kits come in a variety of implementations but generally include powered loudspeaker 36 attached to plug 37, which fits an accessory outlet or a cigarette lighter socket in a vehicle. A hands-free kit also includes cable 38 terminating in plug 39. Plug 39 fits the headset socket on a cellular telephone, such as socket 41 (FIG. 5) in cellular telephone 42. In a sense, a hands-free kit is a special kind of speakerphone and comments relating to one should not be interpreted as excluding the other unless referring to a unique characteristic.

Some hands-free kits use RF signals, like a cordless phone, to couple to a telephone. Some commercially available, hands-free kits use the “BlueTooth®” interface. A hands-free kit also typically includes a volume control and some control switches, e.g. for going “off hook” to answer a call. A hands-free kit may include a visor microphone (not shown) that plugs into the kit.

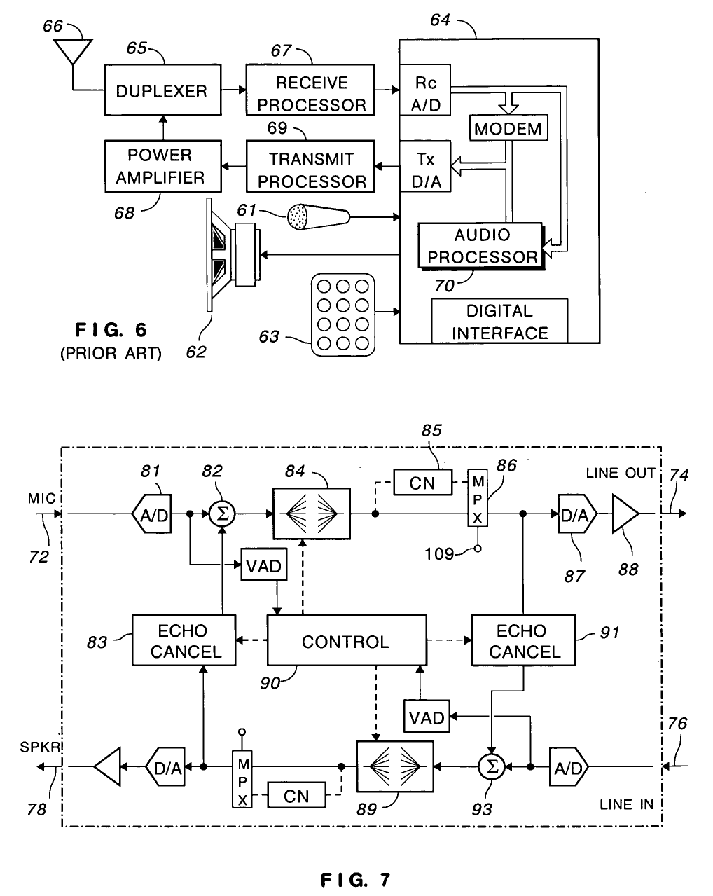

FIG. 6 is a block diagram of the major components of a cellular telephone. Typically, the blocks correspond to integrated circuits implementing the indicated function. Microphone 61, speaker 62, and keypad 63 are coupled to signal processing circuit 64. Circuit 64 performs a plurality of functions and is known by several names in the art, differing by manufacturer. For example, Infineon calls circuit 64 a “single chip baseband IC.” QualComm calls circuit 64 a “mobile station modem.” The circuits from different manufacturers obviously differ in detail but, in general, the indicated functions are included.

A cellular telephone includes both audio frequency and radio frequency circuits. Duplexer 65 couples antenna 66 to receive processor 67. Duplexer 65 couples antenna 66 to power amplifier 68 and isolates receive processor 67 from the power amplifier during transmission. Transmit processor 69 modulates a radio frequency signal with an audio signal from circuit 64. In non-cellular applications, such as speakerphones, there are no radio frequency circuits and signal processor 64 may be simplified somewhat. Problems of echo cancellation and noise remain and are handled in audio processor 70.

FIG. 7 is a detailed block diagram of an audio processor constructed in accordance with the invention. The following describes signal flow through the transmit channel, from MIC input 72 to LINE OUT 74. The receive channel, from LINE IN 76 to SPKR output 78, works in the same way.

A new voice signal entering input 72 may or may not be accompanied by a signal from output 78. The signals from input 72 are digitized in A/D converter 81 and coupled to summation network 82. There is, as yet, no signal from echo canceling circuit 83 and the data proceeds to non-linear processor 84, which is initially set to minimum attenuation in all sub-bands.

The output from non-linear processor 84 is coupled to multiplex circuit 86, where comfort noise from block 85 is optionally substituted for the signal. The output from multiplex circuit 86 is then converted back to analog form by D/A converter 87, amplified in amplifier 88, and coupled to output 74. Data from the two VAD circuits is supplied to control 90, which uses the data for allocating echo elimination and other functions. The data includes noise level. Circuit 83 reduces acoustic echo and circuit 91 reduces line echo. The operation of these last two circuits is known per se in the art.

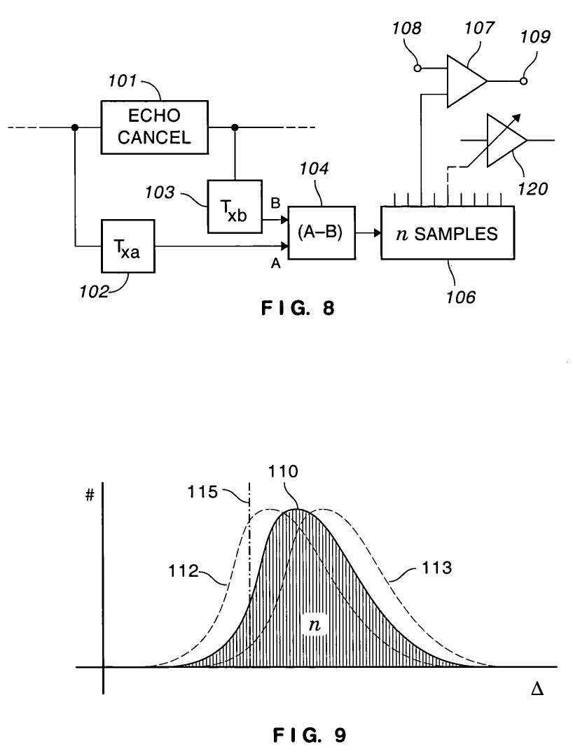

FIG. 8 is a block diagram of a control circuit constructed in accordance with the invention. In a preferred embodiment, the invention monitors the activity of the acoustic echo canceller and provides a variable threshold, e.g., for switching from full duplex to half duplex operation. Echo canceller 101 operates as known in the art to reduce echo. Echo canceller 101 has a variable transfer function such that the output signal is necessarily less than or equal to the input signal to the echo canceller. The magnitude (energy or amplitude) of the input signal sampled by sampling circuit 102. The magnitude of the output signal sampled by sampling circuit 103. The magnitudes are subtracted in difference circuit 104 and n differences are stored in registers 106. The differences are indicative of the level of activity of echo canceller 101 and, by implication, the amount of echo.

FIG. 9 illustrates a histogram of the activity of an echo canceller. For a histogram, the differences (A-B) are grouped into a plurality of ranges and the number (#) of samples in each range is tracked. Curve 110 is a smoothed outline of a histogram. The number of ranges is not critical. In one embodiment of the invention, one hundred ranges were used. Fewer ranges steepens the skirts of curve 110 and increases the peak. More ranges widens the skirts of curve 110 and decreases the peak.

Curve 112 represents less activity by the echo canceller and curve 113 indicates greater activity by the echo canceller. A number of conditions can affect the shape and location of curve 110. That is, curves 112 and 113 have the same shape as curve 110 but this is for illustration only. In practice, the location of the peak and the shape of the curve can change. Activity is monitored at a particular range of differences, represented by dot-dash line 115. As readily seen in FIG. 9, the curves intersect line 115 at distinctly different places. The point of intersection is can be used as a control signal.

Line 115 is located away from the peak of curve 110. This produces two results. A first result is that ambiguity is eliminated as the curve shifts left or right, i.e. duplicate thresholds are avoided. A second result is that the threshold can be made to vary with change in activity or inversely with change in activity. Inverse variation is obtained by locating line 115 as shown. That is, an increase in overall activity will shift the curve to the right, lowering the point at which line 115 intersects the curve. If line 115 were located to the right of the peak in curve 110, an increase in overall activity would raise the point at which line 115 intersected the curve.

As used herein, a “control signal” can be used directly, e.g. to adjust attenuation, or can be compared with another signal for decision making, e.g. to switch to half duplex operation or not.

Referring to FIG. 8, the threshold from registers 106 is coupled to a first input of comparator 107. Input 108 is a second input to comparator 107, which produces an output signal indicating which input signal is greater. The input signal on input 108 represents the current value of the switching threshold for comfort noise. The signal on output 109 can be used a number of places in the audio processing circuitry of a telephone. For example, to control the switching threshold for comfort noise, as indicated by control input 109 in FIG. 6. Other areas include voice detection, threshold adjustment, noise cancellation, and non-linear echo suppression, for example.

Instead of being used as a threshold, an output from registers 106 can be used directly or multiplied by an appropriate coefficient. As illustrated in FIG. 8, an output from one of registers 106 is used to control the gain (or attenuation) of a signal through variable gain amplifier 120. Amplifier 120 can be part of the echo canceller itself.

Converting a plurality of samples to a histogram is a straight-forward statistical conversion. One could, for example, truncate the data by right-shifting the data in a register and using the result as the low order offset to the start address of a group of registers that are incremented accordingly. Line 115 corresponds to one register in the group. More sophisticated calculations could be used instead.

The invention thus provides a control circuit that adapts to changing conditions based upon histogram data. In particular, the control circuit adapts to changing conditions based upon histogram data from the operation of an echo cancelling circuit. The control circuit provides a threshold signal for comparison with other signals or a control signal that can be used directly.

Having thus described the invention, it will be apparent to those of skill in the art that various modifications can be made within the scope of the invention. For example, preferably, register 106 contains a “population” (all samples, not just every x sample based upon some selection criterion). Also, register 106 is preferably cleared and a new population stored, rather than a rolling average type of operation wherein part of the data is new and part is old. Although described in conjunction with echo cancellation, one could use the invention in other parts of an audio processing circuit, e.g. noise reduction or speech detection. Instead of multiplex circuits, one could use variable gain amplifiers on the outputs of circuits 84 and 85 and sum the signals. In this way, one can combine the signals in various proportions, rather than selecting one signal or the other.

What is claimed as the invention is:

1. A method for producing a control signal, said method comprising the steps of:
sampling the difference in magnitude between the output and the input of an electronic circuit having a variable transfer function;
accumulating a plurality of differences and producing a histogram thereof; and
reading the number of samples in a predetermined group in the histogram to produce the control signal.

2. A method for producing a control signal in a telephone having an echo cancelling circuit, said method comprising the steps of:
sampling the difference between the output and the input of the echo cancelling circuit having a variable transfer function;
accumulating a plurality of differences and producing a histogram thereof; and
reading the number of samples in a predetermined group in the histogram to produce the control signal.

3. The method as set forth in claim 2 and further including the step of:
comparing the control signal with another signal.

4. The method as set forth in claim 2 and further including the step of:
applying the control signal to the control input of a variable gain amplifier.

5. The method as set forth in claim 2 and further including the step of:
applying the control signal to the control input of a multiplex circuit.
